(19) United States
(12) Patent Application Publication
(10) Pub. No.: US 2018/0254027 A1
(43) Pub. Date: Sep. 6, 2018

(54) Vibration Isolation Mount

(71) Applicant: Guitar Center, Inc., Westlake Village, CA (US)

(72) Inventor: Robin Richard Slaton, Fort Collins, CO (US)

(73) Assignee: Guitar Center, Inc., Westlake Village, CA (US)

(21) Appl. No.: 15/907,574

(22) Filed: Feb. 28, 2018

Related U.S. Application Data
(60) Provisional application No. 62/465,659, filed on Mar. 1, 2017.

(51) Int. Cl. G10D 13/02; F16F 1/374; F16M 13/02; F16M 11/24; F16M 11/20

(52) U.S. Cl. CPC G10D 13/026; F16F 1/374; F16M 13/02; F16M 2200/021; F16M 11/2078; F16M 2200/025; F16M 11/24

(57) ABSTRACT

A vibration isolation mount, including a vibration damping element having an interior space disposed between a tubular member and a vibration damping wall, the tubular member and the vibration damping wall interconnected by one or more partition walls.

This United States Non-Provisional patent application claims the benefit of U.S. Provisional Patent Application No. 62/465,659, filed Mar. 1, 2017, hereby incorporated by reference herein.

### I. BACKGROUND OF THE INVENTION

Vibration isolation mounts which can be used with percussion instruments to reduce unwanted vibration from the instrument's support stand are described.

### II. SUMMARY OF THE INVENTION

A broad object of the present invention can be to provide a vibration isolation mount, including a vibration damping element having an interior space disposed between a tubular member and a vibration damping wall, the tubular member and the vibration damping wall interconnected by one or more partition walls. The vibration isolation mount further includes one or more partition walls which divide the interior space of the vibration damping element into a plurality of vibrations damping chambers, while one or more of the plurality of vibration damping chambers extend to an external surface of the vibration damping element to define one or more chamber openings at the external surface of the vibration damping element. The plurality of damping chambers of the vibration isolation mount extend between a pair of chamber openings at the external surface of the vibration damping element. The vibration damping element of the vibration isolation mount includes an elastomeric material having a measured durometer hardness of 65A to 105A.

Another broad object of the present invention can be to provide a vibration isolation mount, including a base defining a base internal surface having an aperture and a vibration damping element having a first portion rotatingly engaged with the internal surface of the base and a second portion disposed within the aperture, the second portion of the vibration damping element configured to receive a support member.

Another broad object of the present invention can be to provide a method of making a vibration isolation mount, including configuring a base with an internal surface having an aperture and rotatingly engaging a first portion of a vibration damping element with the internal surface of the base and disposing a second portion of the vibration damping element within the aperture, the second portion of the vibration damping element configured to receive a support member.

Another broad object of the present invention can be to provide a method of using a vibration isolation mount, including obtaining a vibration isolation mount, which comprises a base defining a base internal surface having an aperture and a vibration damping element having a first portion rotatingly engaged with the internal surface of the base and a second portion disposed within the aperture, the second portion of the vibration damping element configured to receive a support member.

Naturally, further objects of the invention are disclosed throughout other areas of the specification, drawings, photographs, and claims.

### III. BRIEF DESCRIPTION OF THE DRAWINGS

FIG. 1 is a bottom perspective view of percussion instrument coupled to a particular embodiment of a vibration isolation mount.

FIG. 2 is a top perspective view of percussion instrument coupled to a particular embodiment of the vibration isolation mount.

FIG. 3 is an exploded view of a particular embodiment of a vibration isolation mount coupled to a percussion instrument.

FIG. 4 is a top plan view of a percussion instrument coupled to a particular embodiment of a vibration isolation mount.

FIG. 5 is a cross sectional view 5-5 as shown in FIG. 4 and view 7-7 as shown in FIG. 7.

FIG. 6 is a bottom plan view of a percussion instrument coupled to particular embodiment of a vibration isolation mount.

FIG. 7 is a bottom plan view of a percussion instrument coupled to particular embodiment of a vibration isolation mount with the base and the vibration dampening element removed from vibration isolation mount.

FIG. 8 is a right side elevation view of a particular embodiment of a vibration isolation mount coupled to a percussion instrument.

FIG. 9 is a left side elevation view of a particular embodiment of a vibration isolation mount coupled to a percussion instrument.

FIG. 10 is a front elevation view of a particular embodiment of a vibration isolation mount coupled to a percussion instrument.

FIG. 11 is a rear elevation view of a particular embodiment of a vibration isolation mount coupled to a percussion instrument.

FIG. 12 is a perspective view of a particular embodiment of a vibration isolation element.

FIG. 13 is a top plan view of a particular embodiment of a vibration isolation element.

FIG. 14 is a bottom plan view of a particular embodiment of a vibration isolation element.

FIG. 15 is a side view of a particular embodiment of a vibration isolation element.

FIG. 16 is perspective view of another particular embodiment of a vibration isolation element.

FIG. 17 is a top plan view of the particular embodiment of the vibration isolation element.

FIG. 18 is bottom plan view of the particular embodiment of the vibration isolation element.

FIG. 19 is a side view of the particular embodiment of the vibration isolation element.

FIG. 20 is a perspective view of another particular embodiment of a vibration isolation mount coupled to a percussion instrument.

FIG. 21 is an exploded view of the particular embodiment of a vibration isolation mount.

FIG. 22 is a top plan view of the particular embodiment of a vibration isolation mount.

FIG. 23 is a bottom plan view of the particular embodiment of a vibration isolation mount.

FIG. 24 is a front elevation view of the particular embodiment of a vibration isolation mount.

FIG. 25 is a rear elevation view of the particular embodiment of a vibration isolation mount.

FIG. 26 is a left elevation side view of the particular embodiment of a vibration isolation mount.

FIG. 27 is a right elevation side view of the particular embodiment of a vibration isolation mount.

FIG. 28 is a cross sectional view 28-28 as shown in FIG. 24.

FIG. 29 is a perspective view of another particular embodiment of a vibration isolation element.

FIG. 30 is a top plan view of the particular embodiment of a vibration isolation element.

FIG. 31 is a bottom plan view of the particular embodiment of a vibration isolation element.

FIG. 32 is a side view of the particular embodiment of a vibration isolation element.

### IV. DETAILED DESCRIPTION OF THE INVENTION

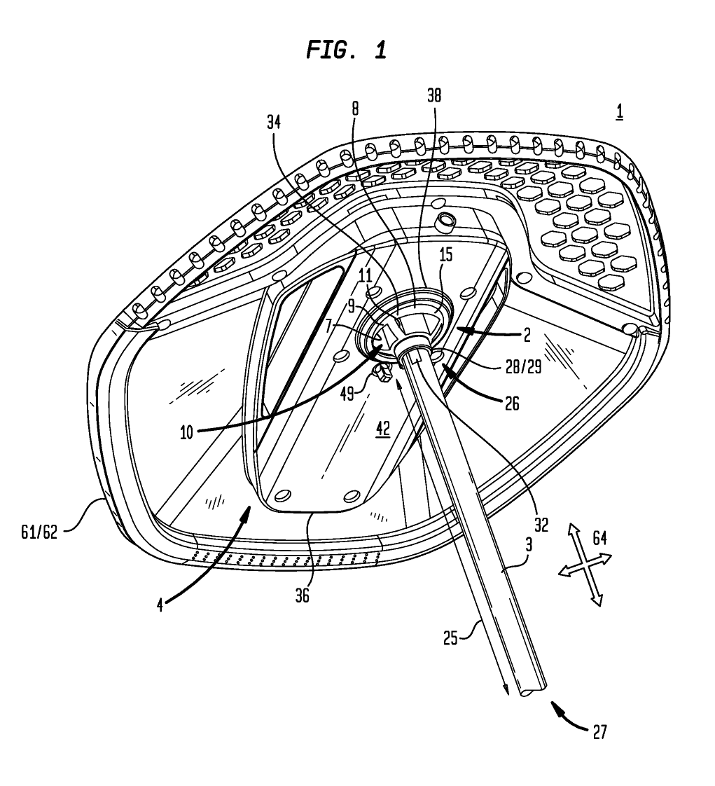

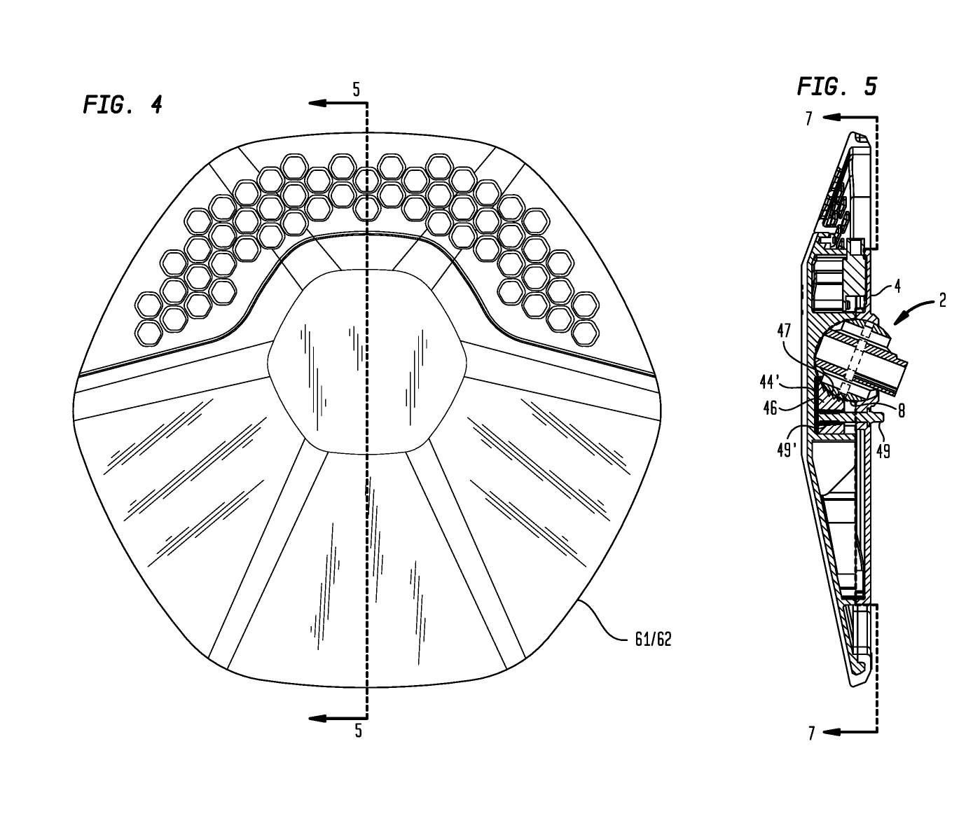

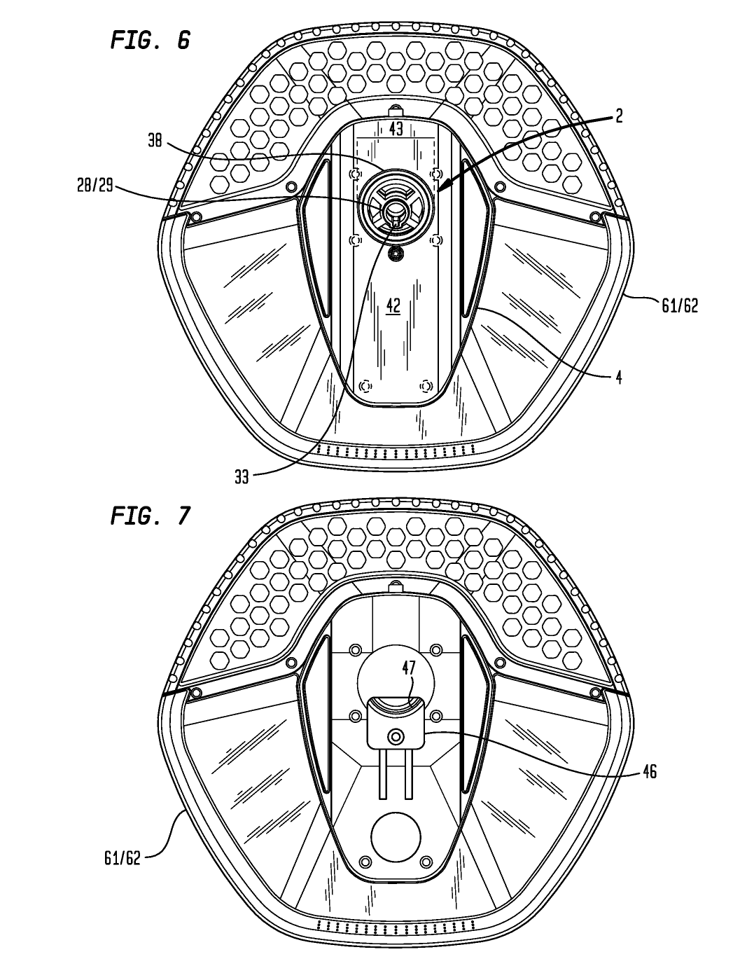

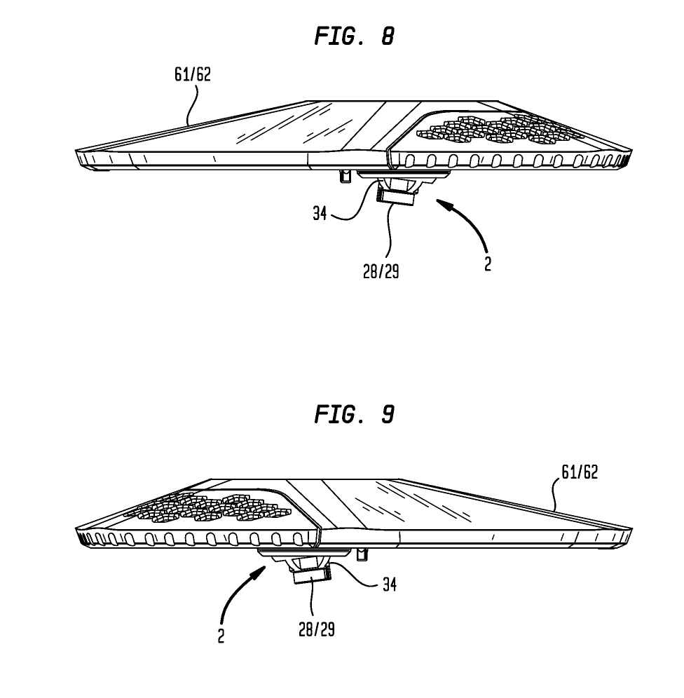

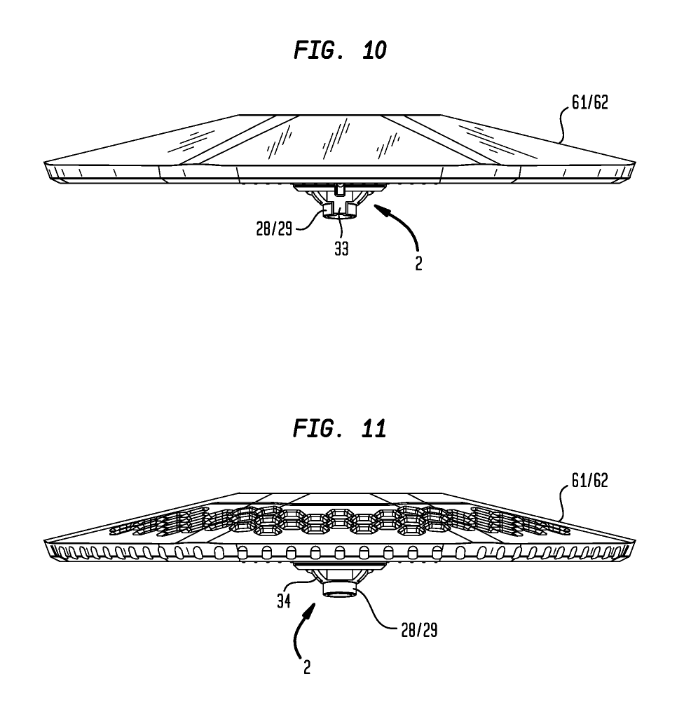

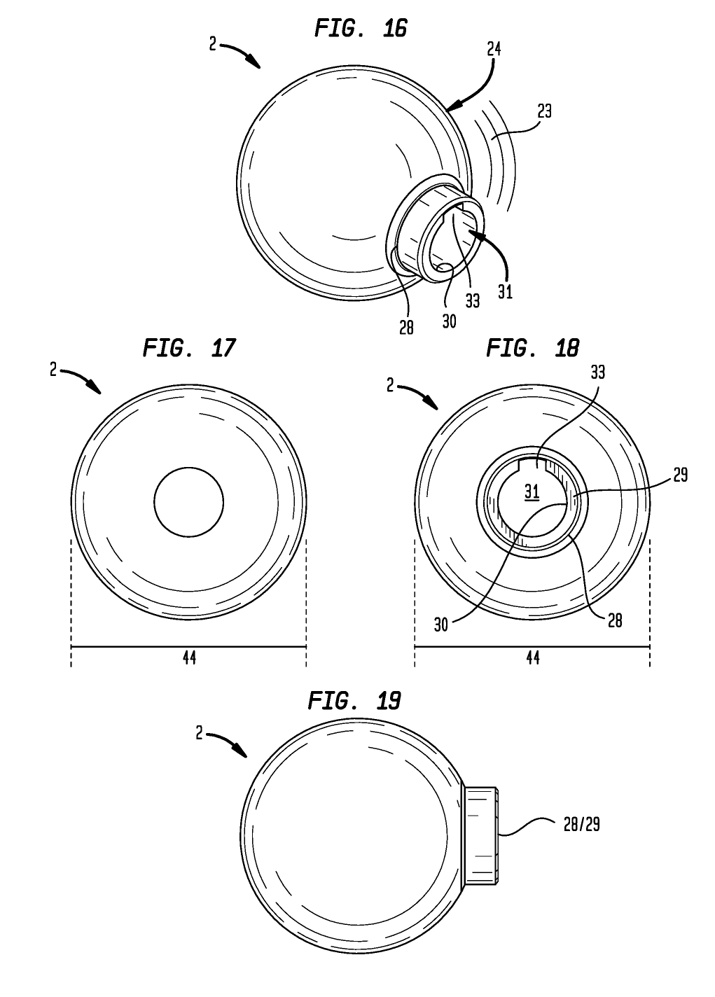

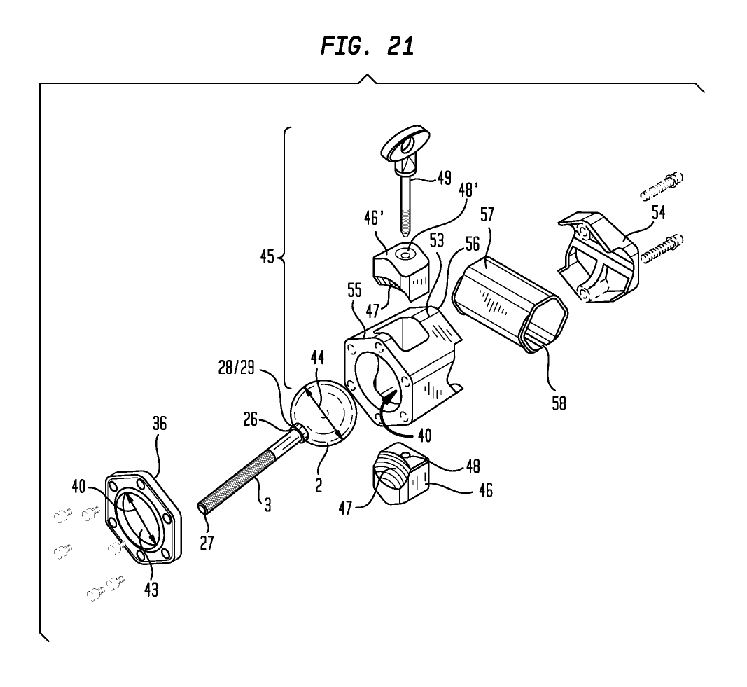

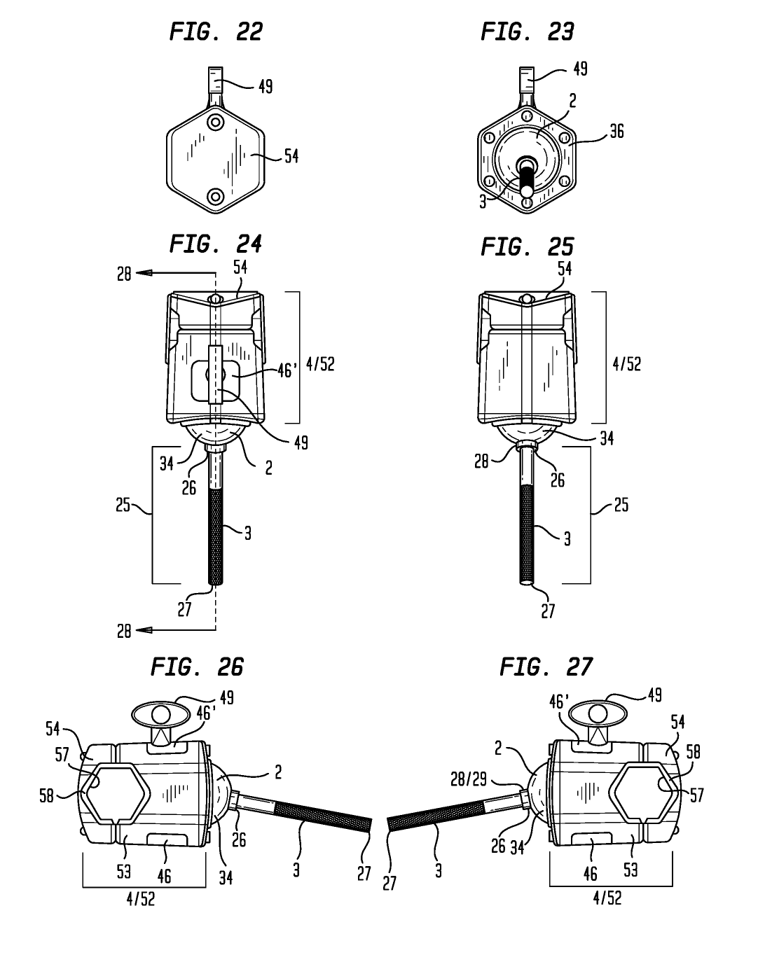

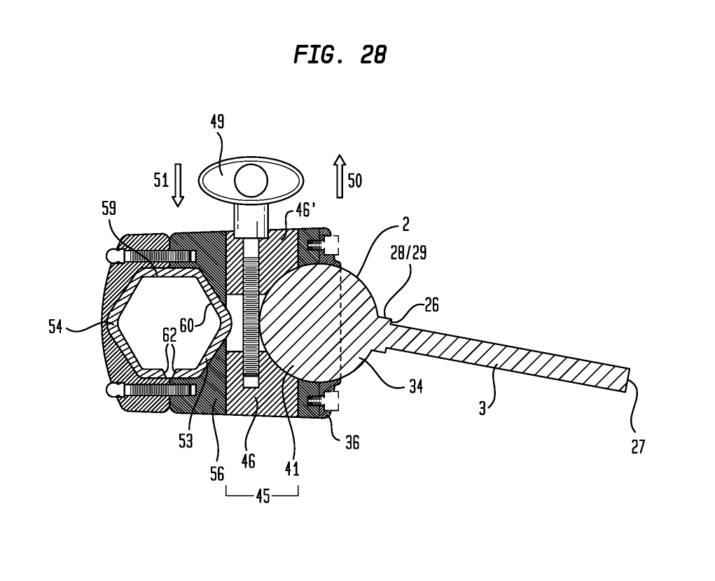

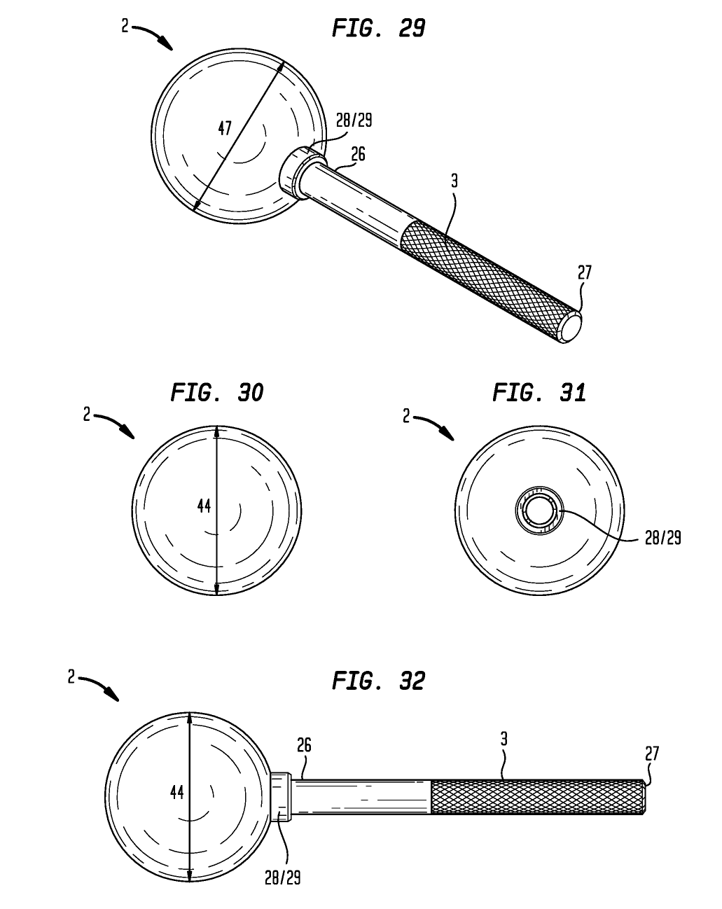

Referring generally to FIGS. 1 through 32, particular embodiments of a vibration isolation mount (1) can include one or more of: a vibration damping element (2), a support member (3), and a base (4). The vibration damping element (2) can have a generally spherical configuration. In particular embodiments, the vibration damping element (2) can be configured as a substantially solid mass of material, or a generally hollow mass of material including a vibration damping wall (7) having an external surface (8) opposite an internal surface (9) defining an interior space (10). As to particular embodiments, the interior space (10) can be divided by one or more partition walls (11) to define one or more vibration damping element chambers (12). Where a plurality of partition walls (13) divide the interior space (10) into a plurality of chambers (14), each of the plurality of chambers (14) can, but need not necessarily, be of substantially similar or dissimilar configuration or volume. As to particular embodiments, the one or more vibration damping element chambers (12) can extend to the external surface (8) of vibration damping element (2) to define one or more chamber openings (15).

By way of example, FIGS. 16 through 19 and 29 through 32 show a particular embodiment of a vibration damping element (2) configured as a substantially solid mass (5) of material (6). The material (6) comprising the vibration damping element (2) can include or consist of one or more of: natural rubber, polytetrafluoroethylene, polyurethane, polypropylene/butyl rubber blend, or other thermoplastic elastomer, plastic, or other like materials, or combination thereof.

The material (6) can have a durometer of between about 65A and about 105A. The durometer can further be selected from the group including or consisting of: about 67.5A and about 72.5A, about 70A to about 75A, about 72.5A to about 77.5A, about 75A to about 80A, about 77.5A to about 82.5 A, about 80A to about 85A, about 82.5 to about 87.5A, about 85A to about 90A, about 87.5A to about 92.5A, about 90A to about 95A, about 92.5A to about 97.5A, about 95A to about 100 A, and about 97.5A to about 102.5A. Durometer is an indirect measure of the stiffness (or the elastic modulus), of an elastomeric material. Low durometer or hardness correlates to a low modulus or stiffness.

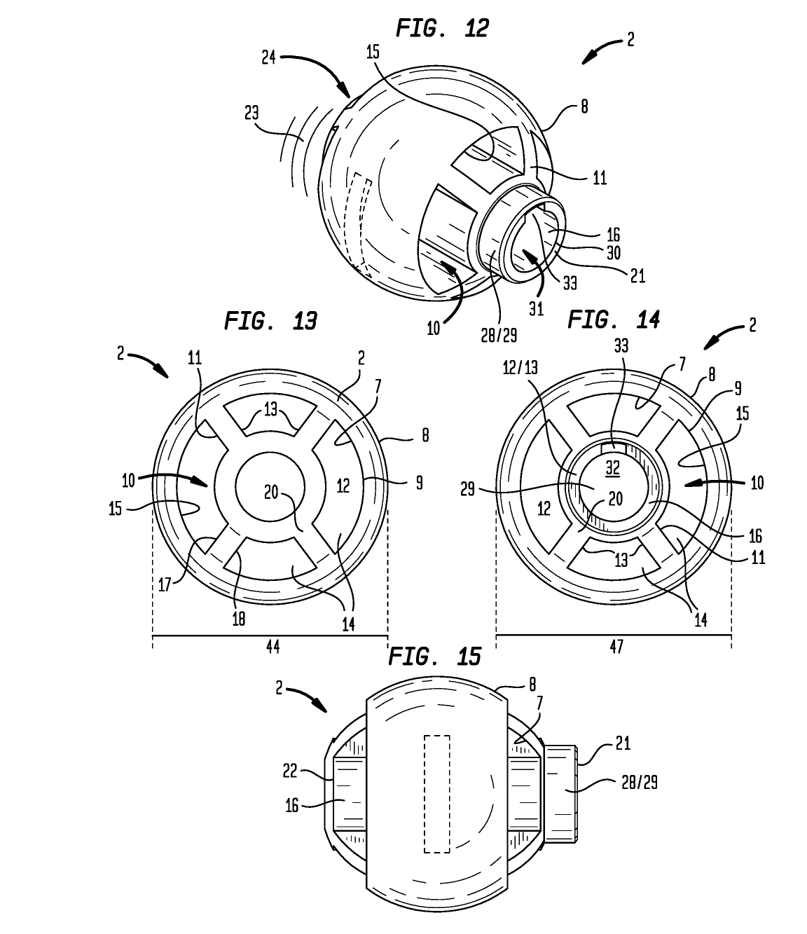

By way of further example, and referring primarily to FIGS. 12 through 15, an illustrative example of a vibration damping element (2) can include a tubular member (16) centrally disposed in an interior space (10) of the vibration damping element (2). One or more partition walls (11) can be disposed between the tubular member (16) and the internal surface (9) defining the interior space (10) and dividing the interior space (10) into a plurality of chambers (14). Each of the plurality of chambers (14) can, but need not necessarily, be of substantially similar or dissimilar configuration or volume. The plurality of chambers (14) can, but need not necessarily extend to the external surface (8) of vibration damping element (2) to define one or more chamber openings (15) at the external surface (8) of the vibration damping element (2). As shown in the particular example of FIGS. 12 through 15, each of a plurality of partition walls (13) can have a partition wall first face (17) opposite a partition wall second face (18) defining a partition wall thickness. The partition wall first face (17) and the partition wall second face (18) can, but need not necessarily, be substantially planar or planar. A partition wall first edge (20) can be joined axially along the length or the entire length of the tubular member (16) between a tubular member first end (21) and a tubular member second end (22). The plurality of partition walls (13) can extend radially outward of the tubular member (16) with the partition wall second face (18) joined to the internal surface of the vibration damping element (2) dividing the interior space (10) into a plurality of damping chambers each axially extending within the interior space between a pair of chamber openings (15) on the external surface (8) of the vibration damping element (2).

The plurality of partition walls (13) can be adjusted in plurality, partition wall area of the first (17) and second faces (18), and durometer to correspondingly adjust the flexural mode, the torsional mode, or Poisson ratio to achieve a pre-selected amount of movement (23) and material damping in the vibration damping element (2) in response to an induced vibration signal (24).

For the purposes of this invention, the term “material damping” means the characterized decay of the vibration amplitude in the material (6). Comparison of damping between particular embodiments of the vibration damping element (2) can be made by a calculation of the damping coefficient in which an induced vibration signal (24) in the material (6) in the time domain is fitted as a sum of exponentially damped sinusoidal functions.

Again, referring generally to FIGS. 1 through 32 and in particular to FIGS. 12 through 15 and FIGS. 16 through 19 and 29 through 32, particular embodiments of a vibration isolation mount (1) can include a support member (3) having a support member length (25) disposed between a support member first end (26) and a support member second end (27). The support member first end (26) can be fixedly or removably coupled to the vibration damping element (2). Fixed or removable coupling of the support member first end (26) to the vibration damping element (2) can, but need not necessarily, be achieved with a coupling element (28) disposed in or between the vibration damping element (2) and the support member first end (26).

In particular embodiments, the coupling element (28) can be configured as a tubular conduit (29) integrated in, or removably engaged to the vibration damping element (2) and configured to accept the support member first end (26). In the illustrative example of FIGS. 12 through 15, the tubular conduit (29) can be fixedly or removably disposed in the tubular member (16) of the vibration damping element (2). In the illustrative examples of FIGS. 16 through 19 and 29 through 32, the tubular conduit (29) can be fixedly or removably disposed in the solid mass (5) of the vibration damping element (2). The tubular conduit (29) includes a conduit internal surface (30) defining a conduit passage (31). The support member first end (26) can be inserted in the conduit passage (31) to fixedly or removably engage the conduit internal surface (30).

Now referring primarily to FIGS. 12 through 19, particular embodiments of the coupling element (28) and the support member first end (26) can further include a mateable key (32) and a keyway (33). In the embodiments shown in FIGS. 12 through 19, the keyway (33) can be disposed in the conduit internal surface (30) and the key can be disposed on the support member first end (26). As shown in the example of FIG. 1, the support member first end (26) can be insertingly engaged to the coupling element (28), to matingly engage the key (32) to the keyway (33) to matingly engage the support member first end (26) to the coupling element (28). Removable coupling of the support member first end (26) to the first portion (34) of the vibration damping element (2) can also be achieved by molding the first portion (34) of the vibration damping element (2) about the support member first end (26), applying adhesive between the coupling of the support member first end (26) and the first portion (34) of the vibration damping element (2), using fastening elements such as screws, nails, brads, or other like fastening elements to removably couple the support member first end (26) to the first portion (34) of the vibration damping element (2). Fastening elements can be used to couple and removably couple components of various parts, as shown in the illustrative examples throughout FIGS. 1 through 32. While embodiments of the coupling element (28) and the support member first end (26) are shown in the Figures as tubular members (16) having a generally circular cross section across the longitudinal axis; this is not intended to preclude embodiments of the coupling element (28) and support member (3) having a square, rectangle, or other geometric cross-sectional configuration. The coupling element (28) and support member (3) can be comprise a metal, plastic, wood, or other like material, or combination thereof.

Now referring primarily to FIGS. 1 through 7 and 20 through 27, embodiments of the vibration isolation mount (1) can include a base (4) configured to retain the vibration damping element (2) allowing multidirectional movement (64) or rotation. In particular embodiments, the base (4) can, but need not necessarily, be configured as vibration damping element housing (35) configured to receive the vibration damping element (2) and an apertured plate (36) which mateably engages the vibration damping element housing (35). The vibration damping element (2) can be retained between the internal surfaces of vibration damping element housing (35) mated to the apertured plate (36).

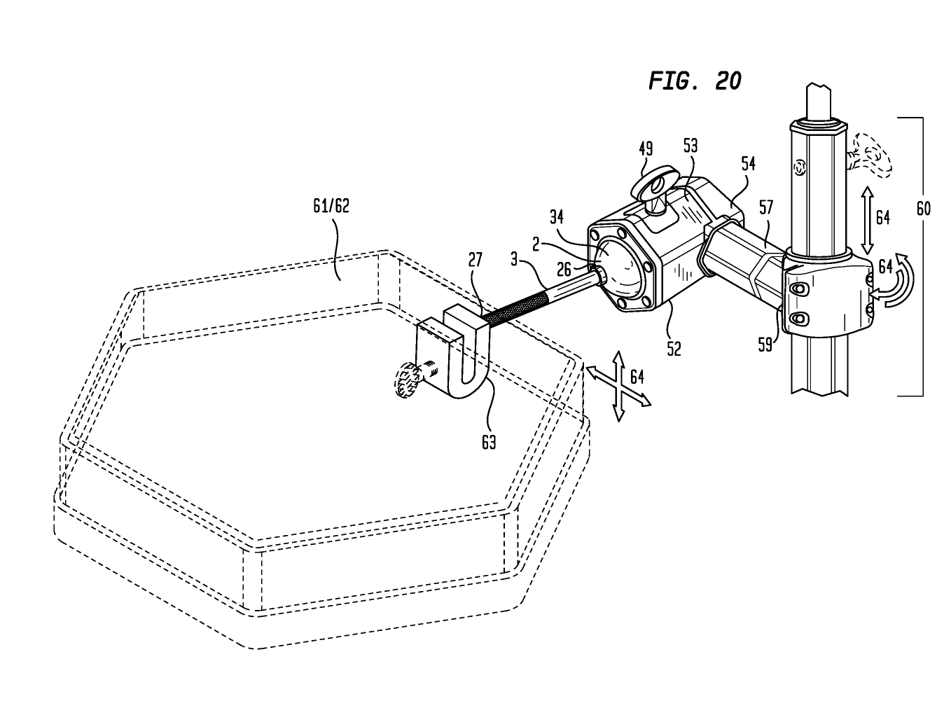

Now referring primarily to FIGS. 20 through 27, particular embodiments of the base (4) can include a vibration damping element housing (35) which mateably engaged with the apertured plate (36) to define a base internal surface (37) spherically contoured to engage the spherical external surface (8) of the vibration damping element (2). The aperture (38) in the apertured plate (36) can have an aperture area (39) which permits the vibration damping element (2) to engage the aperture (38) with a first portion (34) of the vibration damping element (2) located outside (42) of the base (4) and a second portion (41) of the vibration damping element (2) located inside (40) of the base (4). The aperture area (39) bound by the aperture (38) delimits movement (64) or rotation of the vibration damping element (2) inside (40) of the base (4) by engagement of the vibration damping element (2) with the periphery of the aperture (38).

Accordingly, the ratio of the aperture diameter (43) to the vibration damping element diameter (44) can be pre-selected between about 1:0.05 to about 1:0.50 to correspondingly pre-select the amount of movement or rotation (64) in the base (4). In particular embodiments, the ratio of the aperture diameter (43) to the vibration damping element diameter (44) can be selected from the group including or consisting of about 1:0.075 to about 1:0.125, about 1:0.10 to about 1:0.15, about 1:0.125 to about 1:0.175, about 1:0.15 to about 1:0.20, about 1:0.175 to about 1:0.225, about 1:0.2 to about 1:0.25, about 1:0.225 to about 1:0.275, about 1:0.25 to about 1:0.3, about 1:0.275 to about 1:0.325, about 1:0.3 to about 1:0.35, about 1:0.325 to about 1:0.375, about 1:0.35 to about 1:0.40, about 1:0.375 to about 1:0.425, about 1:0.40 to about 1:0.45, about 1:0.425 to about 1:0.475, and about 1:0.45 to about 1:0.49.

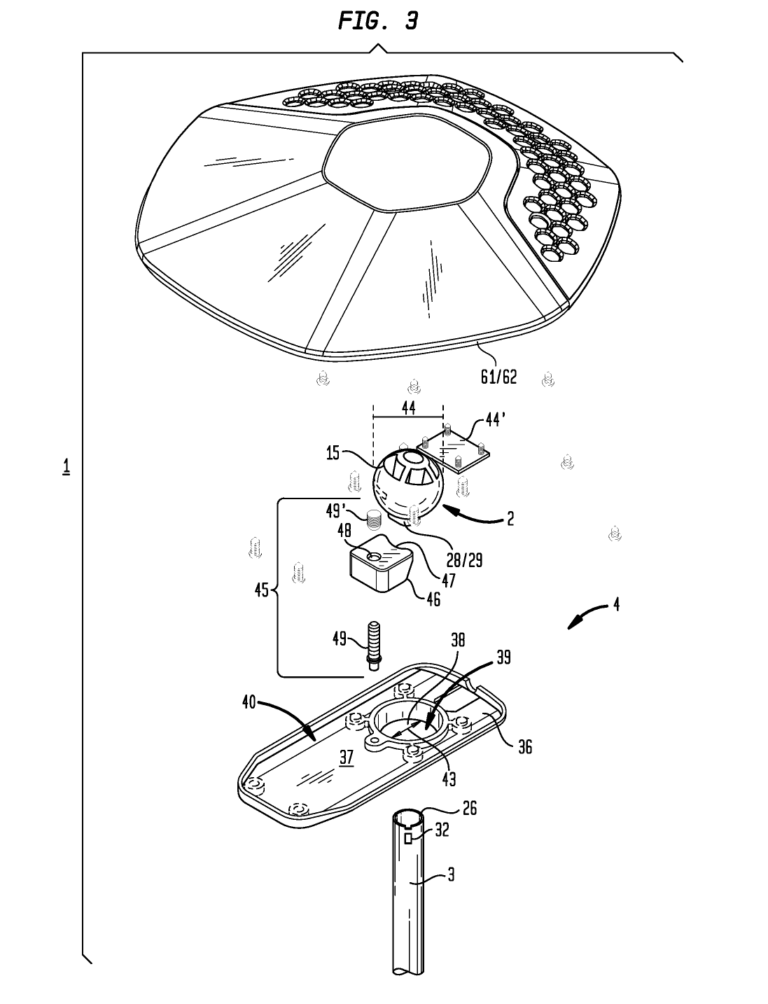

Now referring primarily to FIGS. 3 and 21, particular embodiments can further include a rotation arrest assembly (45) adjustable to allow movement or rotation or arrest movement (64) or rotation of the vibration damping element (2) inside (40) the base (4). As shown in the example of FIGS. 3 through 5, the rotation arrest assembly (45) can include arrest plate (44′) rotation arrest body (46) configured to engage the vibration damping element external surface (8). In particular embodiments, the rotation arrest body (46) can include a generally spherical concavity (47) having a radius about equal the radius of the external surface (8) of the vibration damping element (2). The rotation arrest body (46) can be disposed inside (40) the base (4) adjacently engaged to the vibration damping element (2). The rotation arrest body (46) can have bores (48, 48′) threadingly engaged to arrest adjustment member (49, 49′) whereby rotation of the arrest adjustment members (49, 49′) moves the rotation arrest body (46) in relation to the vibration damping element (2) between an unarrested condition (50) in which the vibration damping element (2) moves or rotates in the base (4) and an arrested condition (51) in which the vibration damping element (2) does not move or rotate in the base (4). Fine adjustment of the arrest adjustment member (49, 49′) allows movement or rotation (64) of the vibration damping element (2) upon varying levels of forcible urging. As shown in FIG. 21, a pair of rotation arrest bodies (46, 46′) can be disposed inside (40) the base (4) on opposite sides of the vibration damping element (2). The rotation arrest bodies (46, 46′) can each include a generally spherical concavity (47) having a radius about equal the radius of the external surface (8) of the vibration damping element (2). The pair of rotation arrest bodies (46, 46′) each include bores (48, 48′) which align and threadingly engage the rotation arrest bodies (46, 46′) with an arrest adjustment member (49), whereby rotation of the arrest adjustment member (49) moves the pair of rotation arrest bodies (46, 46′) in relation to the vibration damping element (2) between an unarrested condition (50) in which the vibration damping element (2) moves or rotates in the base (4) and an arrested condition (51) in which the vibration damping element (2) does not move or rotate within the base (4). The arrest adjustment member (49) can, but not necessarily be a threaded turn key screw. Fine adjustment of the arrest adjustment member (49) allows multidirectional movement (64) or rotation of the vibration damping element (2) upon varying levels of forcible urging.

Now referring primarily to FIGS. 20 through 27, particular embodiments of the base (4) can further include a clamp (52) coupled to the base (4). The clamp (52) can be configured to include a clamp first portion (53) which removably couples to a clamp second portion (54). In particular embodiments, a base housing (55) of the clamp (52) can be configured to provide an integral clamp first portion (53) to which the clamp second portion (54) removably couples by operation of mechanical fasteners. The clamp second portion (54) coupled to the clamp first portion (53) defines clamp internal surface (56) which engages a longitudinally slit tube (57) in which opposed slit edges (58) can be drawn toward one another by compression forces generated by the clamp second portion (54) engaged with the clamp first portion (53). Now referring primarily to FIG. 20, a frame member (59) can be disposed in the slit tube (57) and by operation of the clamp (52) dispose the vibration isolation mount (1) in fixed relation to the frame member (59). The frame member (59) can be part of a framework (60) supporting one or more vibration isolation mounts (1).

Now referring primarily to FIGS. 1 and 20, particular embodiments can further include a struck object (61) such as a percussion instrument (62). In the example of FIG. 1, the struck object (61) (a cymbal) can be removably coupled to the base (4) of the vibration isolation mount (1). As to particular embodiments the base housing (55) can be integrated into the struck object (61). The support member first end (26) can be coupled to the vibration damping element (2) to position the struck object (61).

Now referring primarily to FIG. 20, the vibration isolation mount (1) can be secured in a fixed position on a frame member (59) by operation of the clamp (52). The support member first end (26) can be coupled to the vibration damping element (2) and extend outwardly to terminate in a support member second end (27). A struck object (61) (such as drum pad) can be coupled to the support member second end (27). The support member second end (27) can be removably coupled to the struck object (61) by a struck object support element (63). The struck object support element (63) can be configured secure the struck object (61) to the support member second end (27).

While the Figures provide illustrative examples of the struck object (61) as musical instruments such as a cymbal and a drum, this is not intended to preclude embodiments of the vibration isolation mount (1) coupled to other struck objects (61) or percussion instruments (62) such as tambourines, bells, xylophones, blocks, gongs, or the like.

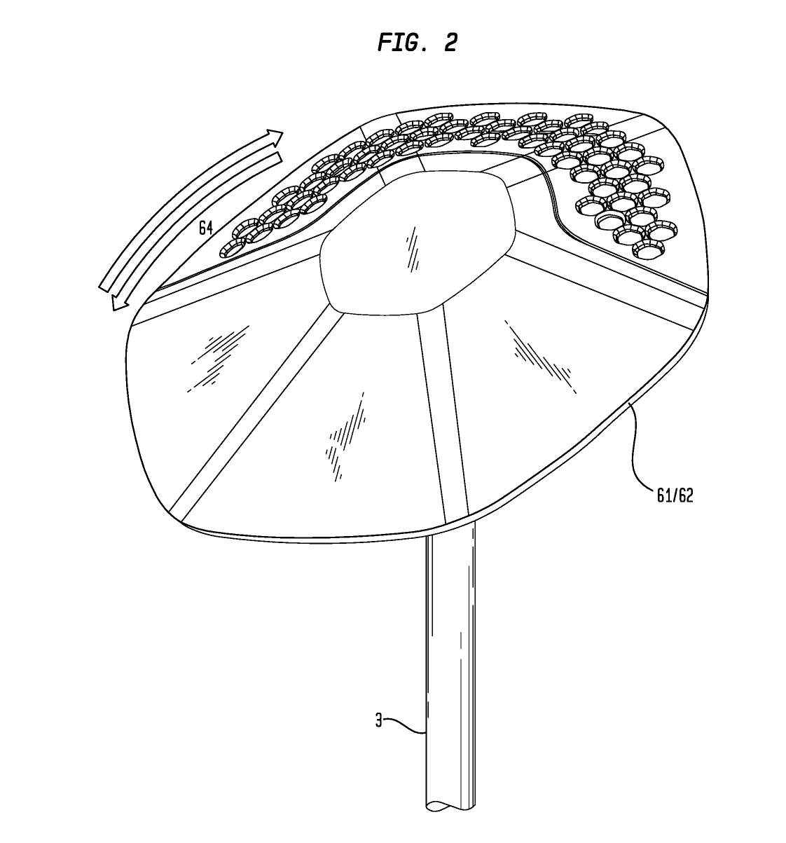

Now referring primarily to FIGS. 2 and 20, the vibration isolation mount (1) permits movement of the struck object (61) to achieve various spatial positions of the struck object (61) and can then arrest the movement of the struck object (61) to maintain the selected spatial position of the struck object (61).

Now referring primarily to FIG. 1 through 19, a method of using a vibration isolation mount (1) can include one or more of: obtaining a vibration isolation mount (1) and coupling a struck object (61) to the base (4) of the vibration isolation mount (1). The method can further include adjusting the base (4) of the vibration isolation mount (1) in relation to the vibration damping element (2), and can further include arresting movement of the base (4) in relation to the vibration damping element (2) by operation of a rotation arrest assembly (45) of the vibration isolation mount (1). The method can further include coupling a support member first end (26) to the vibration damping element (2). The method can further include striking the struck object (61).

Now referring primarily to FIGS. 20 through 32, a method of using a vibration isolation mount (1) can include one or more of: obtaining a vibration isolation mount (1) and coupling a struck object (61) to the vibration damping element (2) of the vibration isolation mount (1). The method can further include adjusting a base (4) of the vibration isolation mount (1) in relation to the vibration damping element (2), and can further include arresting movement of the base (4) in relation to the vibration damping element (2) by operation of a rotation arrest assembly (45) of the vibration isolation mount (1). The method can further include coupling a frame member (59) to the base (4). The method can further include striking the struck object (61).

In further particular embodiments, a method of using a vibration isolation mount (1) can include one or more of: uncoupling the base (4) from a first vibration damping element (2), uncoupling a support member (3) from the vibration damping element (2), coupling a second vibration damping element (2) to the base (4), and coupling the base (4) or the vibration damping element (2) to the struck object (61).

As can be easily understood from the foregoing, the basic concepts of the present invention may be embodied in a variety of ways. The invention involves numerous and varied embodiments of a vibration isolation mount and methods for making and using such vibration isolation mounts including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “support” should be understood to encompass disclosure of the act of “supporting”—whether explicitly discussed or not—and, conversely, were there effectively disclosure of the act of “supporting”, such a disclosure should be understood to encompass disclosure of a “support” and even a “means for supporting.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the vibration isolation mounts herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A vibration isolation mount, comprising:
a vibration damping element having an interior space disposed between a tubular member and a vibration damping wall, said tubular member and said vibration damping wall interconnected by one or more partition walls.

2. The vibration isolation mount of claim 1, wherein said one or more partition walls divide said interior space of said vibration damping element into a plurality of vibrations damping chambers.

3. The vibration isolation mount of claim 2, wherein one or more of said plurality of vibration damping chambers extend to an external surface of said vibration damping element to define one or more chamber openings at said external surface of said vibration damping element.

4. The vibration isolation mount of claim 3, wherein each of said plurality of damping chambers extend between a pair of chamber openings at said external surface of said vibration damping element.

5. The vibration isolation mount of claim 3, wherein said vibration damping element comprises an elastomeric material.

6. (canceled)

7. A vibration isolation mount, comprising:
a base defining a base internal surface having an aperture;
a vibration damping element having a first portion rotatingly engaged with said internal surface of said base and a second portion disposed within said aperture, said second portion of said vibration damping element configured to receive a support member.

8. The vibration isolation mount of claim 7, wherein said vibration damping element comprises a solid vibration damping element.

9. The vibration isolation mount of claim 8, wherein said vibration damping element further comprises one or more partition walls which divide an interior space of said vibration damping element into a plurality of vibrations damping chambers.

10. The vibration isolation mount of claim 9, wherein one or more of said plurality of vibration damping chambers extend to an external surface of said vibration damping element to define one or more chamber openings at said external surface of said vibration damping element.

11. The vibration isolation mount of claim 10, wherein each of said plurality of damping chambers extend between a pair of chamber openings at said external surface of said vibration damping element.

12. The vibration isolation mount of claim 11, further comprising a rotation arrest assembly operable to arrest rotation of said vibration damping element inside of said base.

13. The vibration isolation mount of claim 9, wherein said rotation arrest assembly comprises:
one or more rotation arrest bodies; and
one or more arrest adjustment members adjustably threadingly coupled to said one or more rotation arrest bodies, said arrest adjustment members rotatable to adjust engagement of said one or more rotation arrest bodies with said vibration damping element.

14. The vibration isolation mount of claim 13, further comprising an instrument coupled to said base of said vibration isolation mount.

15. The vibration isolation mount of claim 14, further comprising a coupling element disposed in said vibration damping element, said coupling element configured to accept said support member.

16. The vibration isolation mount of claim 15, further comprising a support member coupled to said vibration damping element, said support member supports said vibration isolation mount coupled to said instrument.

17. The vibration isolation mount of claim 9, further comprising a clamp coupled to said base.

18. (canceled)

19. (canceled)

20. The vibration isolation mount of claim 19, further comprising a frame member disposed in said clamp slit tube, wherein by operation of said clamp disposes said vibration isolation mount in a fixed spatial relation to said frame member.

21. (canceled)

22. The vibration isolation mount of claim 17, further comprising a support member coupled to said vibration damping element.

23. The vibration isolation mount of claim 22, further comprising a coupling element disposed in said vibration damping element, said coupling element configured to accept said support member.

24. The vibration isolation mount of claim 22, further comprising an instrument coupled to said support member.

25-64. (canceled)
